(19) United States
(12) Patent Application Publication
(10) Pub. No.: US 2006/0130145 A1
(43) Pub. Date: Jun. 15, 2006

(54) System and method for analyzing malicious code protocol and generating harmful traffic

(76) Inventors: Byeong Cheol Choi, Daejeon-city (KR); Dong Il Seo, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/152,987

(22) Filed: Jun. 14, 2005

(30) Foreign Application Priority Data
Nov. 20, 2004 (KR) 10-2004-0095547

(51) Int. Cl. G06F 12/14

(52) U.S. Cl. 726/24

(57) ABSTRACT

The provided method and system is a method and system for analyzing the malicious code protocol and generating harmful traffic. The harmful traffic generating method constructs packet protocol information for generating a first attack packet corresponding to the TCP/IP protocol for generating network traffic, and then sets network vulnerability scanning for generating a second attack packet for carrying out network vulnerability scanning. Subsequently, the method constructs attack information for generating a third attack packet in the form of denial of service, and generates harmful traffic using the packet protocol information, network vulnerability scanning and attack information. Accordingly, performance testing of the network security system against malicious code attacks such as the Internet worm can be performed.

This application claims the priority of Korean Patent Application No. 10-2004-0095547, filed on Nov. 20, 2004, in the Korean Intellectual Property Office, the disclosure of which is incorporated herein in its entirety by reference.

### BACKGROUND OF THE INVENTION

1. Field of the Invention

The present invention relates to a method and system for analyzing a malicious code protocol and generating harmful traffic, which tests and measures the performance of a network security system.

2. Description of the Related Art

Malicious code includes worm, virus, back door, trojan horse, malware, adware, and so on. Harmful traffic is the attack traffic generated by the malicious code and other attack signatures.

Conventional malicious code protocol analysis is carried out by checking whether an attack pattern corresponding to previously known malicious code is matched with intrusion detection rules, but it is not performed through automatic CVE (Common Vulnerabilities and Exposures) and malicious code execution for analyzing the harmful file data.

In the generation of harmful traffic, conventional method can generate a simple attack packet, but not an attack packet or harmful traffic operating by a specific scenario (first attack—attack signature, second attack—vulnerability scanning, third attack—attack traffic generation) such as the Internet worm.

### SUMMARY OF THE INVENTION

The present invention provides a malicious code protocol analysis method and a malicious code protocol analyzer capable of analyzing malicious code for testing a network system in connection with CVE, and storing and managing the analysis result (attack pattern).

The present invention also provides a harmful traffic generating method and a harmful traffic generator capable of using malicious code protocol analysis information from the malicious code protocol analyzer or generating harmful traffic in a new form.

A malicious code protocol analyzer according to the present invention includes a malicious code protocol analysis unit, a CVE analysis unit, and a graphic user interface unit. The malicious code protocol analysis unit loads an attack code including a malicious code and analyzes data in the malicious code, to produce the malicious code protocol analysis result. The CVE analysis unit confirms whether the malicious code input from the malicious code protocol analysis unit exists in a CVE database and, when it is determined that the malicious code exists in the CVE database, analyzes CVE information for the malicious code to generate CVE analysis information. The graphic user interface unit constructs the attack code in the malicious code protocol analysis unit and displays the malicious code protocol analysis result and the CVE analysis result.

A harmful traffic generator according to the present invention includes a packet protocol configuration unit, a network vulnerability scanning unit, an attack protocol configuration unit, a packet driver, and a graphic user interface unit. The packet protocol configuration unit constructs packet protocol information for generating a first attack packet corresponding to the TCP/IP protocol for generating network traffic. The network vulnerability scanning unit constructs network vulnerability scanning for generating a second attack packet. The attack protocol configuration unit constructs attack information for generating a third attack packet in the form of denial of service. The packet driver actually generates harmful traffic using the packet information constructed by the packet protocol configuration unit, network vulnerability scanning unit and attack protocol configuration unit. The graphic user interface unit transmits a received set value to the packet protocol configuration unit, network vulnerability scanning unit or attack protocol configuration unit, and displays the packet protocol information, the network vulnerability scanning and attack information, and the harmful traffic generated by the packet driver.

A system for analyzing a malicious code protocol and generating harmful traffic according to the present invention includes a malicious code protocol analyzer including a malicious code protocol analysis unit, a CVE analysis unit and a first graphic user interface unit, and a harmful traffic generator including a packet protocol configuration unit, a network vulnerability scanning unit, an attack protocol configuration unit, a packet driver and a second graphic user interface unit.

The malicious code protocol analysis unit loads an attack code including malicious code and analyzes data in the malicious code to produce the malicious code protocol analysis result. The CVE analysis unit confirms whether the malicious code input from the malicious code protocol analysis unit exists in a CVE database and, when it is determined that the malicious code exists in the CVE database, analyzes CVE information for the malicious code to generate CVE analysis information. The graphic user interface unit constructs the attack code in the malicious code protocol analysis unit and displays the malicious code protocol analysis result and the CVE analysis result.

The packet protocol configuration unit constructs packet protocol information for generating a first attack packet corresponding to the TCP/IP protocol for generating network traffic. The network vulnerability scanning unit sets network vulnerability scanning for generating a second attack packet for performing network vulnerability scanning. The attack protocol configuration unit constructs attack information for generating a third attack packet in the form of denial of service. The packet driver actually generates harmful traffic using the packet information constructed by the packet protocol configuration unit, network vulnerability scanning unit and attack protocol configuration unit. The graphic user interface unit transmits a received set value to the packet protocol configuration unit, network vulnerability scanning unit or attack protocol configuration unit, and displays the packet protocol information, network vulnerability scanning and attack information, and harmful traffic generated by the packet driver.

A method for analyzing a malicious code protocol according to the present invention includes: loading an attack code including malicious code; determining whether the malicious code included in the attack code exists in a CVE database; analyzing CVE and malicious code protocol for the malicious code when it is determined that the malicious code exists in the CVE database; and analyzing malicious code protocol for the malicious code when it is determined that the malicious code does not exist in the CVE database.

A harmful traffic generating method according to the present invention includes: constructing packet protocol information for generating a first attack packet corresponding to the TCP/IP protocol for generating network traffic; setting network vulnerability scanning for generating a second attack packet for carrying out network vulnerability scanning; constructing attack information for generating a third attack packet in the form of denial of service; and generating harmful traffic using the packet protocol information, network vulnerability scanning and attack information.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for analyzing a malicious code protocol and generating harmful traffic according to an embodiment of the present invention;

FIG. 2 is a flow chart showing a method for analyzing a malicious code protocol according to an embodiment of the present invention; and

FIG. 3 is a flow chart showing a method for generating harmful traffic according to another embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms, and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

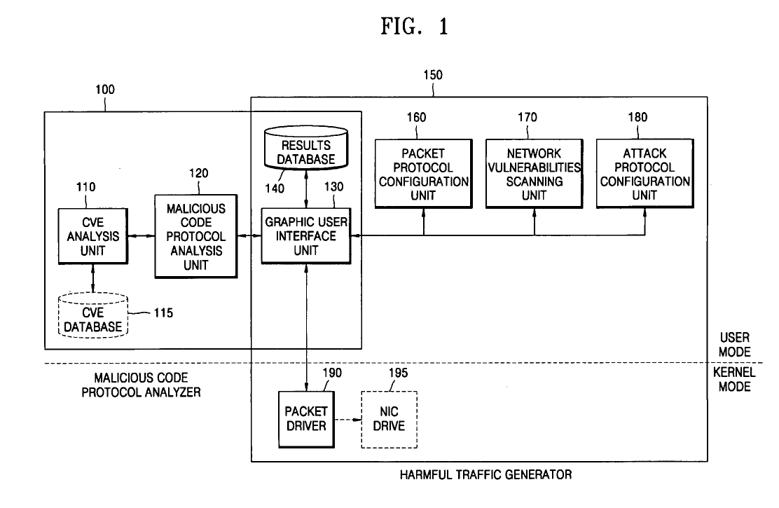

FIG. 1 is a block diagram of a system for analyzing a malicious code protocol and generating harmful traffic according to an embodiment of the present invention. Referring to FIG. 1, the system includes a malicious code protocol analyzer 100 and a harmful traffic generator 150.

The harmful traffic generator 150 generates harmful traffic for testing a network security system. The harmful traffic generator 150 includes a packet protocol configuration unit 160, a network vulnerability scanning unit 170, an attack protocol configuration unit 180, a packet driver 190, a results database 140, and a graphic user interface unit 130.

The packet protocol configuration unit 160 sets the packet information specified by a user by constructing IP (Internet Protocol), TCP (Transmission Control Protocol) or UDP (User Datagram Protocol) data. The user inputs IP header information (MAC addresses or similar), TCP header information or UDP header information through the graphic user interface unit 130, and inputs data information into a payload. The packet protocol configuration unit 160 can construct the desired packet information using the IP header information, TCP header information or UDP header information, input through the graphic user interface unit 130. The packet driver 190 actually generates a packet from the constructed packet information. The actual packet is transmitted through a physical network line to an external device via an NIC (Network Interface Card) drive 195.

The network vulnerability scanning unit 170 sets information for generating a second attack packet such as the Internet worm, which scans network vulnerabilities, after the packet protocol configuration unit 160 constructs the packet information selected by the user. The network vulnerability scanning unit 170 represents the behavior pattern performed before the third attack in the form of DoS (Denial of Service), such as the Internet worm. The packet information set by the network vulnerability scanning unit 170 generates an actual packet according to the packet driver 190. The actual packet is transmitted to an external device through the physical network line via the NIC drive 195.

Network vulnerability scanning carried out by the network vulnerability scanning unit 170 includes ping test, port scanning, OS (Operating System) scanning and so on. The network vulnerability scanning unit 170 scans network vulnerability between the first-stage and third-stage attacks of the Internet worm, to generate effective harmful traffic.

The attack protocol configuration unit 180 determines particulars capable of executing a DoS attack such as the Internet worm. A DoS attack (three-stage attack) can be either an attack on multiple hosts or an attack on a single host. Packet information constructed by the attack protocol configuration unit 180 generates an actual packet according to the packet driver 190. The actual packet is transmitted to an external device through a physical network line via the NIC drive 195.

The attack on multiple hosts automatically changes destination addresses, and controls the number of time and interval that a packet is transmitted. The attack on a single host transmits a large quantity of packets to a single destination. This corresponds to a SYN flooding attack pattern.

The user sets an input value or a check value on the screen of the graphic user interface unit 130. Then, the input value or check value is transmitted to the packet protocol configuration unit 160, network vulnerability scanning unit 170 or attack protocol configuration unit 180. The unit which receives the input value or check value is operated and the result is displayed on the screen of the graphic user interface unit 130.

The packet driver 190 receives the packet information from the packet protocol configuration unit 160, network vulnerability scanning unit 170 and attack protocol configuration unit 180, to actually generate packets and collects packets from external devices. The operating results of the packet driver 190 are displayed on the screen of the graphic user interface unit 130.

The NIC drive 195 is a physical transfer medium, as is usually installed in a computer. The packets generated by the packet driver 190 are transmitted to a physical network via the NIC drive 195. The NIC drive 195 uses a conventional device.

The results database 140 stores attack pattern information (set information) generated by the packet protocol configuration unit 160, network vulnerability scanning unit 170 and attack protocol configuration unit 180, so that the information can be reused.

The malicious code protocol analyzer 100 extracts a harmful traffic attack suite to test the network security system. The malicious code protocol analyzer 100 includes a malicious code protocol analysis unit 120, a CVE analysis unit 110, the results database 140, and the graphic user interface unit 130.

The malicious code protocol analysis unit 120 loads a malicious code attack file (for example, actual code in the form of exe) to analyze data in malicious code.

The CVE analysis unit 110 analyzes CVE information (TCP/IP protocol information, attack pattern information and so on) corresponding to the malicious code to automatically display a protocol pattern on the screen of the graphic user interface unit 130.

The graphic user interface unit 130 provides an interface capable of displaying the results (malicious code attack pattern information) of the malicious code protocol analysis unit 120 and CVE analysis unit 110 and storing the results in the results database 140.

The results database 140 stores the malicious code attack pattern information generated by the malicious code protocol analysis unit 120 and CVE analysis unit 110 so that the information can be reused.

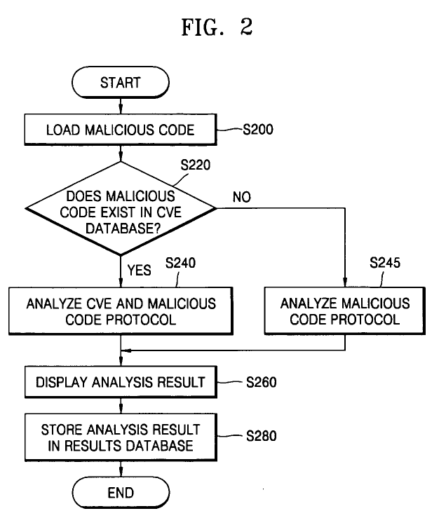

FIG. 2 is a flow chart showing a method for analyzing a malicious code protocol according to an embodiment of the present invention. FIG. 2 shows the operation of the malicious code protocol analyzer 100 for extracting a harmful traffic attack suite to test the network security system.

The user pushes a loading button in the graphic user interface unit 130 to open an attack code file including malicious code, in the step S200. Then, it is determined whether the malicious code included in the attack code exists in a CVE database 115 (shown in FIG. 1) in the step S220. The process routine goes to the step S240 when it is determined that the malicious code exists in the CVE database 115, but goes to the step S245 when the malicious code does not exist in the CVE database 115.

In the step S240, the CVE analysis unit 110 carries out CVE analysis, and the malicious code protocol analysis unit 120 performs malicious code data analysis. Here, the CVE analysis involves analyzing CVE information (TCP/IP protocol information, attack pattern information and so on) corresponding to the malicious code. The malicious code protocol analysis involves analyzing data in the malicious code. In the step S245, the malicious code protocol analysis unit 120 analyzes the data in the malicious code.

Next, in the step S260, the CVE analysis result and malicious code protocol analysis result obtained in the step S240, and the malicious code protocol analysis result acquired in the step S245, are displayed on the screen of the graphic user interface unit 130. Subsequently, the CVE analysis result and malicious code protocol analysis result are stored in the results database 140 in the step S280.

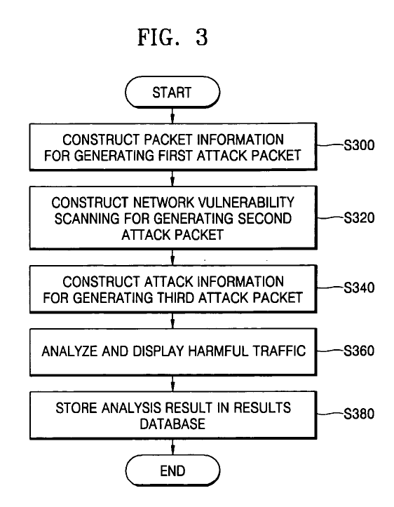

FIG. 3 is a flow chart showing a method for generating harmful traffic according to another embodiment of the present invention. FIG. 3 shows the operation of the harmful traffic generator 150 for generating harmful traffic in order to test the network security system.

First of all, packet information for generating the first attack packet corresponding to the TCP/IP protocol for generating network traffic is constructed, in the step S300. Then, network vulnerability scanning for generating the second attack packet for executing network vulnerability scanning, such as the Internet worm, is set in the step S320.

Subsequently, attack information for generating the third attack packet in the form of DoS, such as the Internet worm, is constructed in the step S340. Attack state information about harmful traffic, generated by the steps S300, S320 and S340, is analyzed and the analysis result is displayed on the screen of the graphic user interface unit 130, in the step S360. The analysis result obtained in the step S360 is stored in the results database 140 in the step S380.

The method and system for analyzing a malicious code protocol and generating harmful traffic according to the present invention can analyze the pattern of multi-form and multi-stage attacks such as by a worm or virus, and automatically generate harmful traffic to test the network security system more effectively. This enables performance testing of the network security system against malicious code attacks such as the Internet worm.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A malicious code protocol analyzer comprising:
a malicious code protocol analysis unit which loads attack code including malicious code and analyzes data in the malicious code to produce the malicious code protocol analysis result;
a CVE analysis unit which confirms whether the malicious code input from the malicious code protocol analysis unit exists in a CVE database and, when it is determined that the malicious code exists in the CVE database, analyzing CVE information for the malicious code to generate CVE analysis information; and
a graphic user interface unit which constructs the attack code in the malicious code protocol analysis unit and displays the malicious code protocol analysis result and the CVE analysis result.

2. The malicious code protocol analyzer of claim 1, further comprising a results database which stores and manages the malicious code protocol analysis result and the CVE analysis result.

3. The malicious code protocol analyzer of claim 1, wherein the CVE information corresponds to at least one of TCP/IP protocol information and attack pattern information.

4. A harmful traffic generator comprising:
a packet protocol configuration unit which constructs packet protocol information for generating a first attack packet corresponding to the TCP/IP protocol for generating network traffic;
a network vulnerability scanning unit which constructs network vulnerability scanning for generating a second attack packet;
an attack protocol configuration unit which constructs attack information for generating a third attack packet in the form of denial of service;
a packet driver which actually generates harmful traffic using the packet information constructed by the packet protocol configuration unit, network vulnerability scanning unit and attack protocol configuration unit; and
a graphic user interface unit which transmits a received set value to the packet protocol configuration unit, network vulnerability scanning unit or attack protocol configuration unit, and displays the packet protocol information, network vulnerability scanning and attack information, and harmful traffic generated by the packet driver.

5. The harmful traffic generator of claim 4, further comprising a results database which stores and manages the packet protocol information, network vulnerability scanning and attack information constructed by the packet protocol configuration unit, network vulnerability scanning unit and attack protocol configuration unit.

6. A system for analyzing a malicious code protocol and generating harmful traffic, comprising:
a malicious code protocol analyzer including a malicious code protocol analysis unit which loads an attack code including malicious code and analyzes data in the malicious code to produce the malicious code protocol analysis result, a CVE analysis unit which confirms whether the malicious code input from the malicious code protocol analysis unit exists in a CVE database and, when it is determined that the malicious code exists in the CVE database, analyzes CVE information for the malicious code to generate CVE analysis information, and a first graphic user interface unit which constructs the attack code in the malicious code protocol analysis unit and displays the malicious code protocol analysis result and the CVE analysis result; and
a harmful traffic generator including a packet protocol configuration unit which constructs packet protocol information for generating a first attack packet corresponding to the TCP/IP protocol for generating network traffic, a network vulnerability scanning unit which sets network vulnerability scanning for generating a second attack packet for performing network vulnerability scanning, an attack protocol configuration unit which constructs attack information for generating a third attack packet in the form of denial of service, a packet driver which actually generates harmful traffic using the packet information constructed by the packet protocol configuration unit, network vulnerability scanning unit and attack protocol configuration unit, and a second graphic user interface unit which transmits a received set value to the packet protocol configuration unit, network vulnerability scanning unit or attack protocol configuration unit and displays the packet protocol information, network vulnerability scanning and attack information, and harmful traffic generated by the packet driver.

7. The system of claim 6, wherein the first and second graphic user interfaces are common to the system.

8. The system of claim 6, further comprising a results database which stores and manages the malicious code protocol analysis result, the CVE analysis result, the packet protocol information, and network vulnerability scanning and attack information constructed by the packet protocol configuration unit, network vulnerability scanning unit and attack protocol configuration unit.

9. A method for analyzing a malicious code protocol comprising:
(a) loading an attack code including malicious code;
(b) determining whether the malicious code included in the attack code exists in a CVE database;
(c) analyzing CVE and malicious code protocol for the malicious code when it is determined that the malicious code exists in the CVE database; and
(d) analyzing malicious code protocol for the malicious code when it is determined that the malicious code does not exist in the CVE database.

10. The method of claim 9, further comprising displaying the analysis results of (c) and (d) through a graphic user interface unit.

11. The method of claim 9, further comprising storing and managing the analysis result of (d) in a results database.

12. A harmful traffic generating method comprising:
constructing packet protocol information for generating a first attack packet corresponding to the TCP/IP protocol for generating network traffic;
setting network vulnerability scanning for generating a second attack packet for carrying out network vulnerability scanning;
constructing attack information for generating a third attack packet in the form of denial of service; and
generating harmful traffic using the packet protocol information, network vulnerability scanning and attack information.

13. The method of claim 12, further comprising analyzing the generated harmful traffic and displaying the analysis result on the screen of a graphic user interface.

14. The method of claim 12, further comprising storing and managing the generated harmful traffic in a results database.
